(19) United States
(12) Patent Application Publication
(10) Pub. No.: US 2024/0065182 A1
(43) Pub. Date: Feb. 29, 2024

(54) Grow System Stack

(71) Applicant: Hall Labs LLC, Provo, UT (US)

(72) Inventors: David R. Hall, Provo, UT (US); Jerome Miles, Spanish Fork, UT (US); Quinn Riley, Provo, UT (US)

(73) Assignee: Hall Labs LLC, Provo, UT (US)

(21) Appl. No.: 18/454,763

(22) Filed: Aug. 23, 2023

Related U.S. Application Data
(60) Provisional application No. 63/373,326, filed on Aug. 23, 2022.

(51) Int. Cl. A01G 9/26; A01G 9/02; A01G 9/24

(52) U.S. Cl. CPC A01G 9/26; A01G 9/023; A01G 9/246; A01G 9/247; A01G 9/249

(57) ABSTRACT

A system for growing plants is described which includes a first platform, configured to support a first set of plants thereon. The system also includes a second platform, spaced above the first platform a sufficient distance to allow for full growth of the plants thereunder, and configured to support a second set of plants thereon. A first movable frame is suspended above the first platform and below the second platform. The first movable frame has a first array of grow lights mounted thereon. A second movable frame is suspended above the second platform and has a second array of grow lights mounted thereon. The system also includes a lift system configured to raise and lower the movable frames so as to maintain each array of grow lights within a predetermined distance above each set of plants as it grows.

### CROSS-REFERENCE TO RELATED APPLICATIONS

This application is a continuation-in-part of U.S. Provisional Patent Application No. 63/373,326, filed Aug. 23, 2022, and entitled “Stackable Grow System,” the entire disclosure of which is incorporated herein by reference.

### TECHNICAL FIELD

The present disclosure is directed to systems and methods for efficiently growing plants.

### BACKGROUND

Various plants have been grown indoors with artificial light, in order to protect from pests or provide optimum light energy to the growing plants. Cannabis is one such plant that is often found grown indoors. Meanwhile, the benefits and uses of Cannabis are becoming more widely recognized at the same time legal and stigmatic barriers to Cannabis are diminishing. Many growers of Cannabis have developed indoor growing systems over the years. These systems can provide optimization of growing conditions year-round. However, such systems often consume large amounts of energy and water. It is beneficial to minimize the inefficiencies of such systems to optimize growing conditions and to address the sometimes delicate nature of the Cannabis plants.

### SUMMARY

Embodiments of the present disclosure are directed to a system for growing plants in a controlled environment. The system includes a first platform, configured to support a first set of plants thereon, and a second platform, spaced above the first platform a sufficient distance to allow for full growth of the plants thereunder, and configured to support a second set of plants thereon. A first movable frame is suspended above the first platform and below the second platform and having a first array of grow lights mounted thereon. A second movable frame is suspended above the second platform and having a second array of grow lights mounted thereon. The system also includes a lift system configured to raise and lower the first movable frame so as to maintain the first array of grow lights within a predetermined distance above the first set of plants as it grows, and configured to raise and lower the second movable frame so as to maintain the second array of grow lights within the predetermined distance above the second set of plants as it grows.

Further embodiments of the present disclosure are directed to a method for growing plants. The method includes providing a first shelf, configured to support a first set of plants thereon. A second shelf is provided and, spaced above the first shelf a sufficient distance to allow for full growth of the first set of plants thereunder, and configured to support a second set of plants thereon. A first movable shelf is provided, with the first moveable frame suspended above the first shelf and below the second shelf. The first movable frame has a first array of grow lights mounted thereon. A second movable frame is suspended above the second shelf and has a second array of grow lights mounted thereon. A lift system configured to raise and lower the first movable frame is provided. The first array of grow lights is maintained within a predetermined distance above the first set of plants as they grow. The second array of grow lights is maintained a predetermined distance above the second set of plants as they grow. The first and second movable frames raise and lower so as to maintain the first and second arrays of grow lights within the predetermined distance above the first and second set of plants as they grow.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a perspective view of a raisable grow system with a 6×12 array of fans suspended over a 3×6 array of plants.

FIG. 1B is a side view showing the hoists that provide lift for the movable platforms, as well as the power and water to run them.

FIG. 1C is an isometric illustration of a hoist system for use with a plant to be cultivated indoors according to embodiments of the present disclosure.

FIG. 2 is an isometric view of a hoist unit according to embodiments of the present disclosure.

FIG. 3 is a side view of the hoist according to embodiments of the present disclosure.

FIG. 4 is an isometric illustration of a hoist and movable frame according to embodiments of the present disclosure.

FIG. 5 is an isometric view from below a hoist unit according to embodiments of the present disclosure.

FIG. 6 is a bottom isometric view of a movable frame for use with a hoisting system for an indoor growing facility according to embodiments of the present disclosure.

FIG. 7 is a close-up view of a fan for use with a movable frame 180 of a hoisting system for an indoor growing facility according to embodiments of the present disclosure.

FIG. 8 is an isometric view of a stackable grow system 200 according to embodiments of the present disclosure.

FIG. 9 shows a system with a 2×12 array of fans.

FIG. 10 shows three systems as shown in FIG. 9, placed adjacent to each other.

FIG. 11 is a perspective view of a stacked growing system.

FIG. 12 is a side view of the system of FIG. 11.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “lifter” is meant to refer to a device capable of raising and/or lowering an object by mechanical means such as a motor, spool, and a line.

As used herein, “line” is meant to refer to an elongated cable, wire, or cord that is generally flexible and has tensile strength sufficient to withstand the weight of an object to be lifted by a hoist of the present disclosure.

As used herein, “plant” refers to a tree, bush, or other vegetation that is to be cultivated using the systems and methods of the present disclosure. Plant includes but is not limited to a Cannabis plant. Reference to specific species of plants, such as Cannabis, does not preclude application of the systems and methods of the present disclosure with other varieties of plants and vegetation.

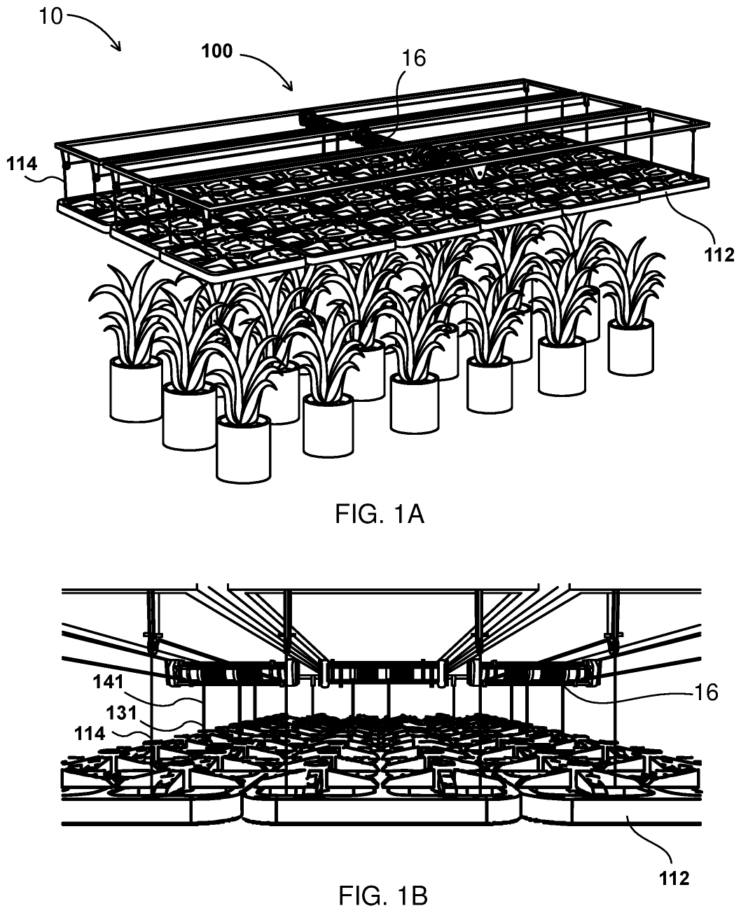

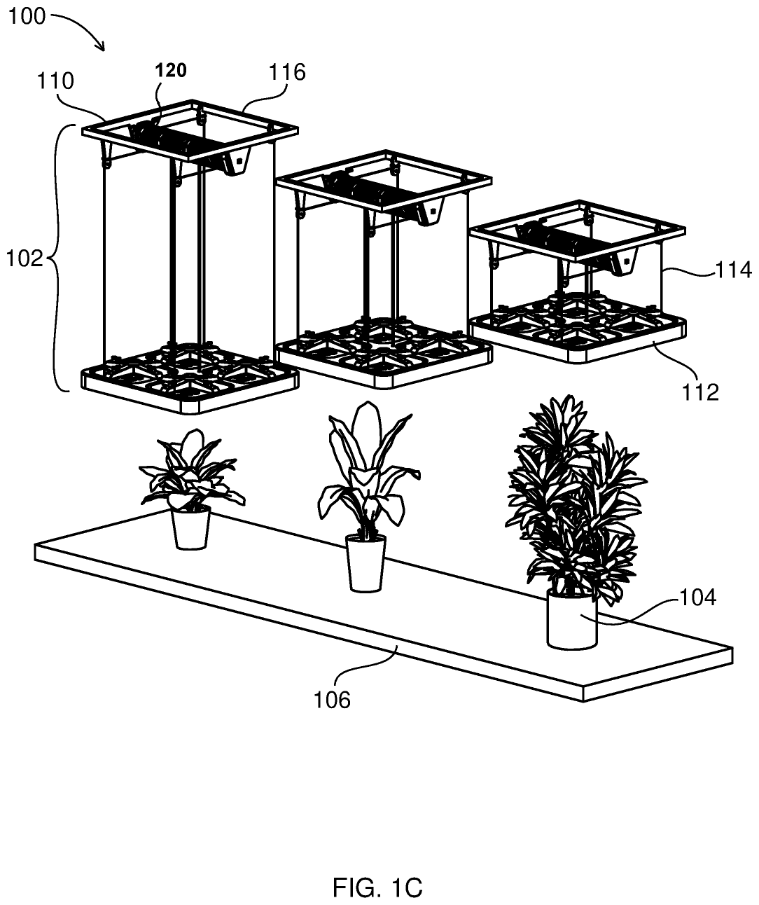

FIG. 1A is an isometric view of a hoist-supported indoor growing facility 10 according to embodiments of the present disclosure. The facility 10 can be scaled up or down to include any desired number of plants. The facility 10 includes a lift system 100 that can raise and lower a series of movable frames 112 upward and downward to accommodate the varying heights of the plants at different times in the life cycle of the plant: lower to start, then higher as the plants grow. The lift system 100 includes one or more hoists 16 that are able to raise and lower the movable frames 112 using mechanical lines 114. The hoists 16 include other lines as well, such as an electrical power line and a hydraulic line. The hoists 16 include spools for each type of line and are configured to spool in and out the various types of lines at a similar rate to avoid excess slack or tension in any of the lines. The electric lines provide power for fans, sensors, and lights and any other component on the movable frames 112. The hydraulic lines can deliver water, fertilizer, pesticides, or any other type of fluid that can be sprayed or dripped onto the plant.

FIG. 1B is an end view of the facility 10 of Figure A according to embodiments of the present disclosure. In the depicted embodiment, the lift system includes three hoists 16 and each hoist has mechanical lines 114, electrical lines 131 and hydraulic lines 141. The spools for each type of line can be a different size to accommodate the thickness of each line to allow the spools to wind and unwind without causing excess slack or tension in the lines. The movable frames 112 can include a connection with the electrical lines 131 and hydraulic lines 141 and can also include further wiring and fluid conduits that allow the electrical power and the fluids to be delivered throughout the movable frames 112. There may be many misters, atomizers, sprayers, or other fluid delivery nozzles or outlets that receive water and/or other fluids from the hydraulic lines 141, and these fluids can be directed throughout the movable frames 112 to reach each outlet. In some embodiments there is sufficient pressure in the hydraulic line that a generally similar amount of fluid is delivered from nozzles near the hydraulic lines as well as those at more remote locations such as at the edges. In some embodiments, the water used in the water misters is pre-heated by thermal energy emitted by the grow lights.

The electric lines 131 provide power to various components in the movable frames 112, such as fans, lights, and sensors. The movable frames 112 can include a number of sensors that can detect a variety of conditions, such as temperature, humidity, light, and distance to the plants. In some embodiments the movable frames 112 include a proximity sensor that determines a distance between the plants and the movable frames 112. As the plants grow the distance will be reduced. If the movable frames 112 are too close the hoists 16 can raise the movable frames 112. In other embodiments application of certain fluids and/or air to the plants can be achieved from a certain distance to the plants. The movable frames 112 can be moved to any desired distance within the range of the hoists 16 to achieve a fluid or air delivery. For example, if it is desired to water plants from a close distance, the hoists 16 can lower the movable frames 112 down to be nearer the plants, at which point the water is applied, and after which the hoists 16 can return the movable frames 112 to the standard position.

In some embodiments the sensors are optical sensors that can include cameras for video or photographic inspection of the plants. The sensors can also include temperature sensors that can monitor a temperature of the plant, the soil, the environment around the plant, etc. In some embodiments the sensors can include a sensor that can detect the presence of insects that may be harmful to the plant. The sensors can allow early detection of such insects or other living organisms such as a moss or fungus that may be present on or around the plant.

In some embodiments, the system is provided with humidity sensors. Signals from such sensors can be fed into the controller, which may, in response, activate the water misters.

It should be appreciated that there may be a different number of hoists 16 for a given number of movable frames 112 in different indoor grow facilities. There may be multiple hydraulic lines 141 to provide fluids to the movable frames 112.

FIG. 1C is an isometric illustration of a lift system 100 for use with a plant to be cultivated indoors according to embodiments of the present disclosure. The lift system 100 is shown with three modular units 102; however, it is to be appreciated that a lift system 100 of the present disclosure can include any number of modules in any configuration. The lift system 100 includes a fixed bracket 110 that is mounted to a stationary object such as a ceiling or a frame. Individual lift units 102 include a movable frame 112 coupled to the fixed bracket 110 via one or more lines 114. The lines 114 attach to the hoist 120. The lines 114 can be extended or retracted to raise or lower the movable frame 112. The lift system 100 is for use with a plant 104 resting on a base 106 below the lift units 102. The three plants depicted are at various stages of growth, from the smallest on the left to the largest on the right. As the plant grows taller, the movable frame 112 is moved upward away from the base 106 and therefore maintains a desired distance from the plant itself. Accordingly, the lift system 100 allows for more precise application of light, water, air, or any other substance or resource deployed from a closer delivery point than would otherwise be possible.

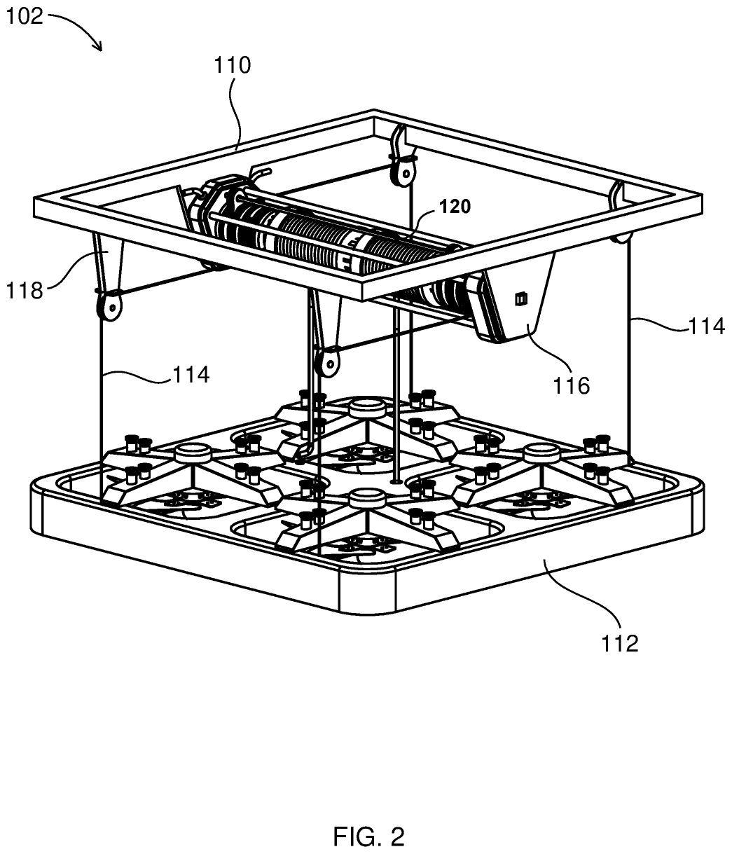

FIG. 2 is an isometric view of a lift unit 102 according to embodiments of the present disclosure. The lift unit 102 includes a fixed bracket 110 that is mounted to a ceiling or a frame or another non-moving structure over the plant. The lift unit 102 also includes a hoist 120 that extends and retracts the lines 114. The lift unit 102 also includes a movable frame 112 that is coupled to the lines 114 and is raised and lowered by the hoist 120 winding and unwinding the lines 114.

The fixed bracket 110 includes a hoist support 116 that serves as an anchor point for rotation of the hoist 120. The fixed bracket 110 also includes pulley supports 118 that allow the lines 114 to extend horizontally from the hoist 120, pass through the pulley supports 118, and from that point downward to provide multiple points of contact for the lines 114. The movable frame 112 is therefore stabilized and will not tip or swing excessively, despite being suspended by flexible lines 114.

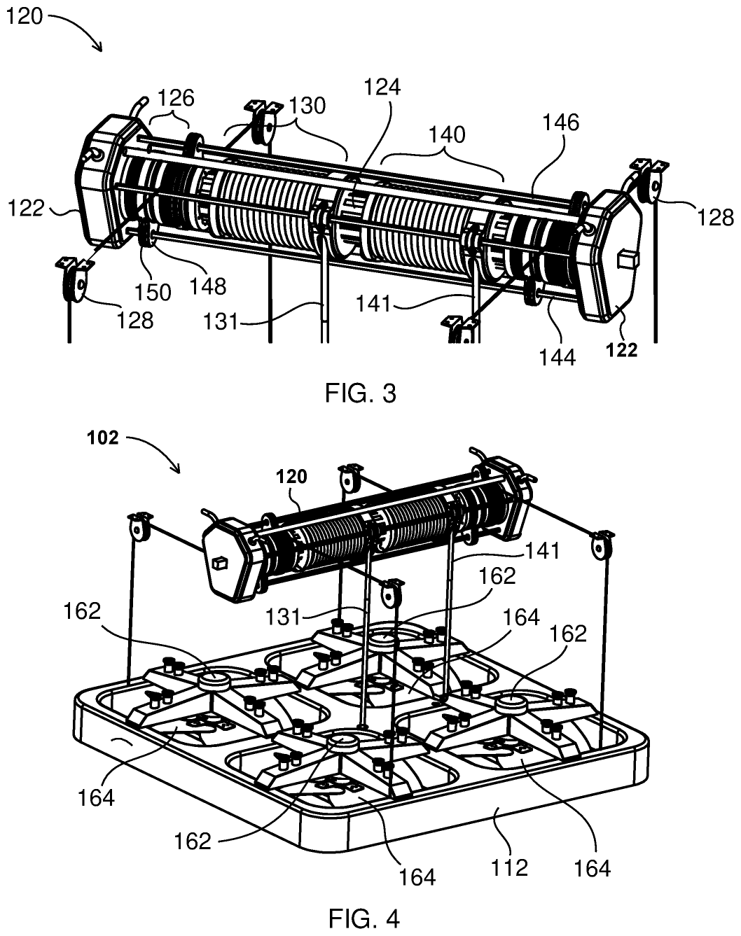

FIG. 3 is a side view of the hoist 120 according to embodiments of the present disclosure. One example of a suitable hoist is described and depicted in U.S. Patent Publication No. U520230166950, titled “Hoisting device with multiple line types on driveshaft,” the entire disclosure of which is incorporated herein by reference. The hoist 120 includes end plates 122 on either end of the hoist 120. The end plates 122 can house an electric motor that is used to operate the hoist 120. In some embodiments the end plates 122 do not house the motor and the motor is elsewhere and the end plates 122 are a mechanical support point. The hoist 120 also includes a driveshaft 124 that is a generally cylindrical member having a generally uniform shape such that components can be slid onto and off of the driveshaft 124. The driveshaft 124 may have a faceted face, such as a hexagonal shape to enable components mounted to the driveshaft 124 that have a matching surface to rotate with the driveshaft 124. In other embodiments the driveshaft 124 is round and components are mounted thereto via friction.

The hoist 120 also includes one or more spool assemblies mounted to the driveshaft 124. The spool assemblies are configured to rotate with the driveshaft 124, and each has a line that extends and retracts. In some embodiments the various spool assemblies can carry a different type of line, such as a mechanical line for supporting weight, an electrical line 131 for power, a hydraulic or fluid line 141 for supplying fluids such as water, medicine, or other fluids. The hoist 120 can includes a line spool assembly 126 that carries a mechanical line 114. The mechanical line can be passed to a pulley 128 and down. The hoist 120 can include a power spool assembly 130 that carries an electrical cord 131. The hoist 120 can also include a hydraulic spool assembly 140 that carries a hydraulic or fluid line 141 for fluids such as water.

Each of the spool assemblies with the various line types may have different dimensions to accommodate the characteristics of the lines. For example, the electrical cord 131 may have a larger diameter than that mechanical line 114. To accommodate this the dimensions of the electrical spool assembly 130 can be different such that each unit of rotation of the driveshaft results in the same linear pay out of the line from each of the spool assemblies. Accordingly, raising and lowering the movable frame 112 also winds and unwinds a proper amount of each line and there is no extra slack or tension in any of the lines.

Examples of embodiments of lifters, spools, and motors are shown in U.S. Pat. Nos. 9,624,076 and 9,975,745, which are incorporated herein by reference in their entireties.

The hoist 120 can also include a rail 144 that is generally parallel with the driveshaft 124 and includes a wheel 148 that helps to prevent misalignment of the lines onto their respective spool assemblies. The wheel 148 can cause tension on the lines as the lines are unwound from the spool assemblies, and through a one-way bearing, can freely rotate as the lines are wound onto the spool assemblies. The hoist 120 can also include a rod 146 that provides mechanical stiffness to the assembly and prevents twisting of the driveshaft, rail, and spool assemblies.

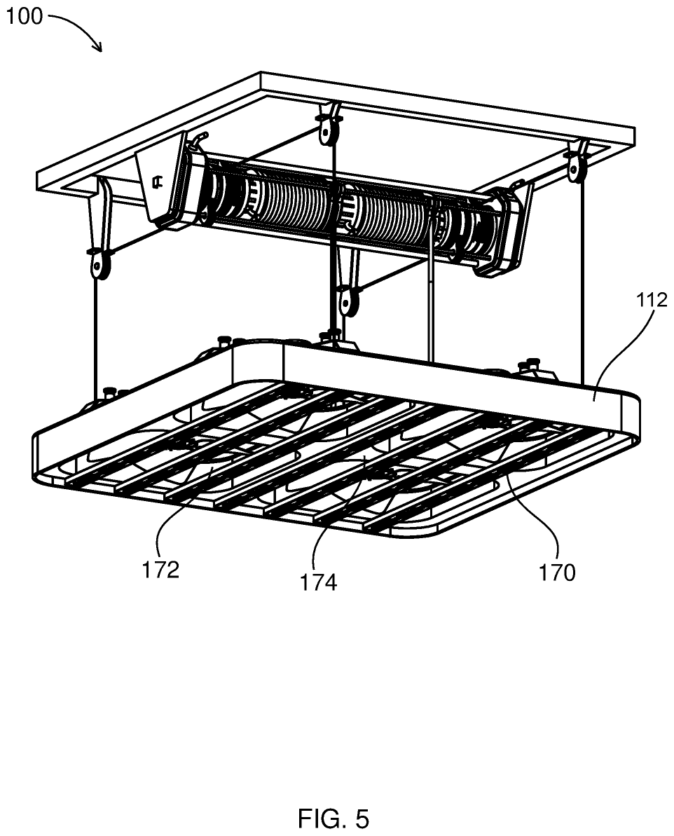

FIG. 4 is an isometric illustration of a hoist 120 and movable frame 112 according to embodiments of the present disclosure. The fixed bracket 110 is not pictured to avoid obscuring other components. The movable frame 112 can include fan housings 162 that support fans 164. The fans 164 can run using electrical power from the power line 131 directed through the hoist 120. The fans 164 can be operated in two directions: one to direct air downward onto the plant, and another to direct air upward over the plant. The movable frame 112 can also include fluid delivery units on an underside of the movable frame 112 that can receive fluid such as water from the hydraulic line 141. The movable frame 112 includes features for directing power and fluids from their respective lines to the fans, lights (shown in FIG. 5) and fluid delivery units.

FIG. 5 is an isometric view from below a hoist unit 102 according to embodiments of the present disclosure. The movable frame 112 also includes lights 170 on an underside of the movable frame 112 that can be ultraviolet lights that are commonly used in indoor grow factories. The lights 170 can receive power from the electrical line 131. The movable frame 112 also includes fluid delivery units 172 such as spritzers that can atomize fluid such as water for the plants. Other fluids such as fertilizer or medicine or other desired substances can be delivered to the plants in this way.

The movable frame 112 can also include sensors 174 that can detect light, temperature, moisture, and or distance. In an area on or around the plants. The movable nature of the movable frame 112 allows for precise monitoring even as the plants below grow taller. The observed characteristics obtained by the sensors 174 can enable automatic operation of the hoist unit. A controller (not pictured) can be used with the hoist system 120 and can provide logic to operate the hoist 120 to move the movable frame 112 and to deliver air, fluid, or other resources to the plant. Each individual plant may have different needs, different temperatures, moisture contents, and as such may need a slightly different application of light, water, etc. which is enabled by the hoist system of the present disclosure. In some embodiments raising and lowering of each individual hoist unit is automated such that even without direct supervision from a trained professional, the plant below is receiving a precise amount of light, water, air, and other nutrients or resources. All this is achieved without the inefficiencies experienced by other, static grow factories which apply water, air, light, and other resources to large tracts of plants, without regard to the needs of each individual plant. The result is a more efficient grow factory that yields better results because each plant receives just what is needed.

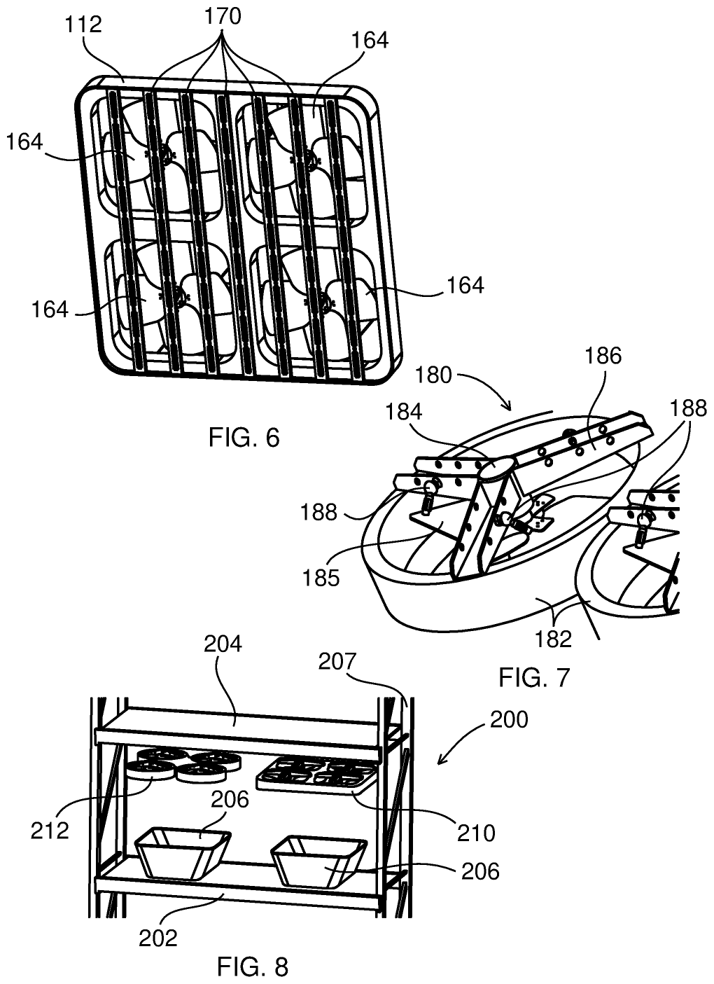

FIG. 6 is a bottom isometric view of a movable frame 112 for use with a hoisting system for an indoor growing facility according to embodiments of the present disclosure. The movable frame 112 can include a generally rectangular outer frame and can house a number of fans 164. In the embodiment shown there are four fans 164. The movable frame 112 also includes lights 170 that cover the movable frame 112. The lights 170 can be LED strips or other ultraviolet light structures that are attached to the movable frame 112 and can provide the energy to grow the plants. The intensity of the light provided by the lights 170 can be controlled by the controller and can vary during the lifetime of the plant. In some embodiment the lights 170 are directed at a water line and can heat up the water in the water line.

FIG. 7 is a close-up view of a fan for use with a movable frame 180 of a hoisting system for an indoor growing facility according to embodiments of the present disclosure. The movable frame 180 includes a fan support 182 structure that supports a fan motor 184 that powers fan blades 185. The fan frame 180 also includes fan support beams 186 that connect the fan support 182 to the fan motor 184. The movable frame 180 can also include water misters 188 that are attached to the fan support beams 186 and can be directed in various directions to spray atomized water and other fluids onto the plants below the movable frame 180. The misters 188 can be connected to the water line (see FIG. 4).

FIG. 8 is an isometric view of a stacking grow system 200 according to embodiments of the present disclosure. The system 200 includes a first platform 202, a second platform 204, and a frame 207 supporting the first platform 202 and second platform 204. In some embodiments each platform is modular and can be separated from other platforms and frames. The first platform 202 has plants 206 thereon that will grow taller over time. The second platform 204 can include a movable frame 210 of the rectangular type or a movable frame 212 of the type shown in FIG. 7. In either case the second platform 204 can also include a hoist unit (not shown) that supports the movable frame over the plants on the platform below. The movable frames can be raised and lowered as needed and in response to a direct instruction or in response to measuring that the plant has grown and the distance between the movable frame and plant needs to be increased. The system 200 can be modular and stackable and can also be grouped with multiple modular units placed next to one another. The platforms support the plants and the hoisting units and can be similar to the hoisting units shown and described elsewhere herein.

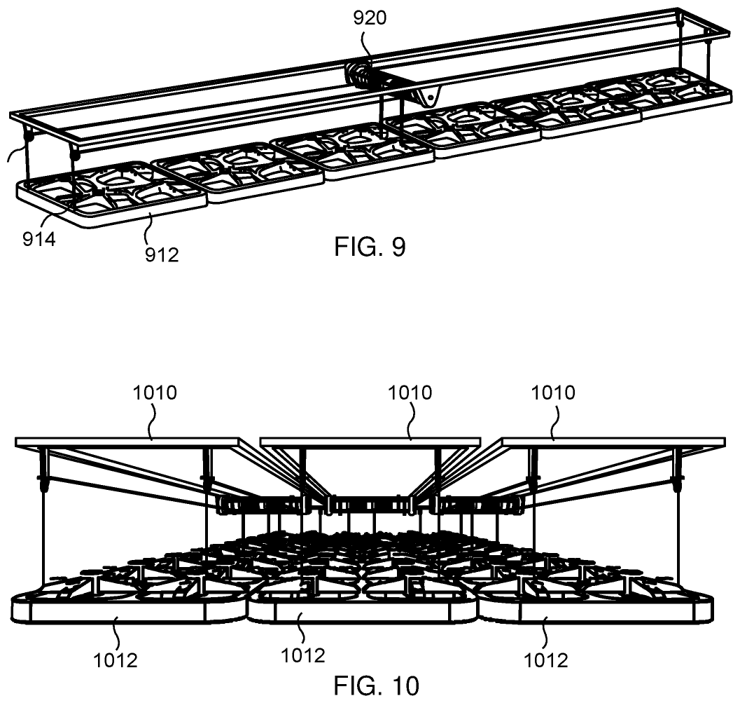

FIG. 9 below shows a modular movable frame system with six modules. Each frame 912 includes 6 movable modules, the movable modules each include a 2×2 array of fans, or in other words each array of fans in the movable frame is a square of 4 fans together. As can be seen, the system uses 4 pulleys such as pulley 915 at the corners of the platform, so that the 4 lifting lines such as line 914, which are wound and unwound from the same hoist 916, can be attached to the four corners of the movable frame. Each module can be individually configured to accommodate a specific plant. Thus, the modular frame can be set up for many plants of one species, or the frame can be set up to accommodate multiple different plant species. Setting up a frame for one species of plant is preferred because while the modules of each frame can be calibrated for different plants, the height of all the modules of the frame is consistent across the frame. Each frame will move all the modules to the same height because all the modules in one frame are connected together.

FIG. 10 shows a system with multiple movable frames, in this case three frames with multiple modules that result in three 2×12 arrays of fans are placed side by side. Each of these frames can be independently raised and lowered to optimize growth of the plants underneath each frame. Each frame could have its own species of plant and the frame height, light output, humidity provided by the misters, and fans would be tailored for that species. While each frame can be calibrated for a different plant species, it is most effective to have all the plants on one level be the same species because the conditions will be more consistent across the level than having multiple plant species with multiple different environmental calibrations. If only one level is being used, then varying the conditions according to each frame is possible in the programing of the frame conditions.

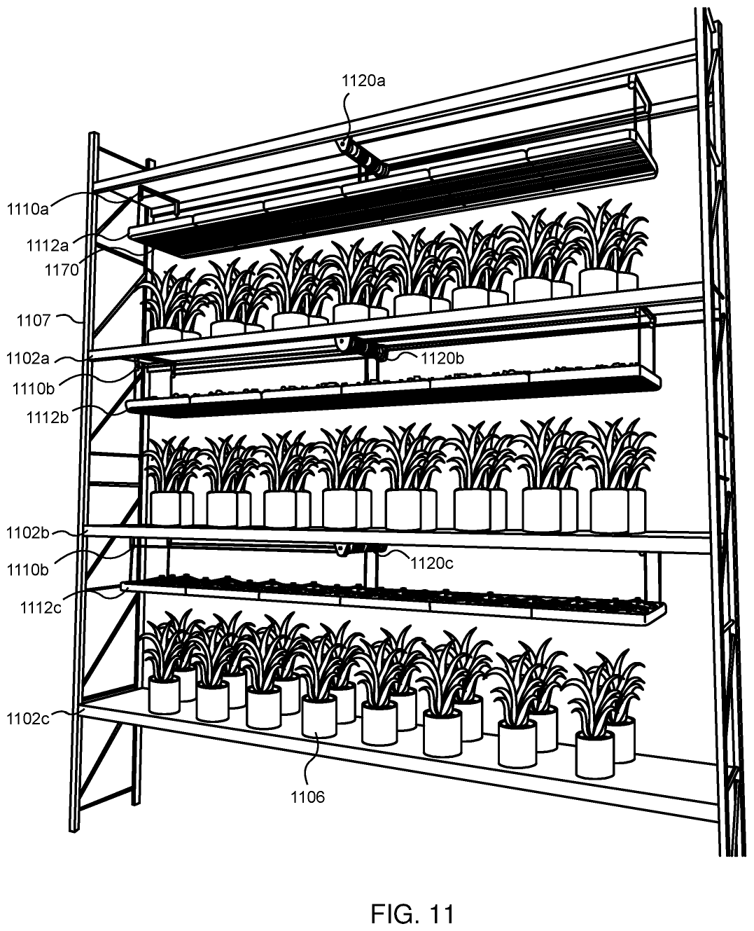

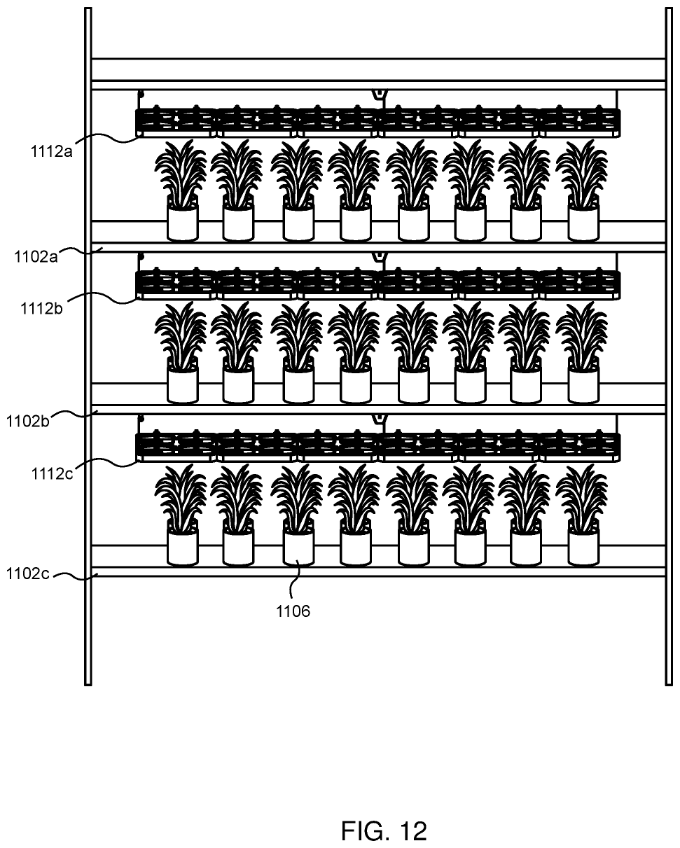

FIGS. 11 and 12 depict a stacking grow system that includes three platforms or shelves, each with multiple potted plants thereon. Growing plants on stacking platforms or shelves makes better use of available space. This is especially relevant for growing plants where specific conditions affect the quality of the plants or the compounds within the plants. For example, the wavelength of light hitting the plant can alter the compounds stored in the plants. One example of this is Cannabis, when high levels of UV-B light hit the surface of the Cannabis plant, more THC is stored in the Cannabis plant. When high levels of UV-B light hit the Cannabis plant, more CBD, CBG, and THCV compounds are stored in the Cannabis plant. Other herbaceous plants have similar properties.

The plants are placed on platforms or shelves large enough to accommodate the fully grown plants. FIGS. 11 and 12 show the plants grown in pots such as pot 1106. While pots are depicted as the growing container, other containers are equally viable to use. Such containers include trays or troughs that cover the entire platform or shelf, connected containers such as plant flats, and any other container suitable to hold individual plants or groups of plants. When the plants are placed in the containers and the containers placed on the platforms or shelves 1102a, 1102b, and 1102c, the plants will be small. In some instances, the plants are grown from seed. When the containers with the new plants or seeds are placed on the platforms or shelves, the movable frames, 1112a, 1112b, and 1112c will be lowered to an optimal position. The hoists 1120a, 1120b, and 1120c will let out the lines connected to movable frames 1112a, 1112b, and 1112c.

Frames 1112a, 1112b, and 1112c have lights 1170 attached to the bottom of the frames. The output of lights 1170 can be calibrated for optimal growing efficiency of the desired plants. There are many lights available which will provide adequate light for growing. Some lights can be calibrated for different wavelengths. Different wavelengths of lights can affect plant growth and the incorporation of certain properties into the plant. Therefore, lights that have an output which can be calibrated are most desirable.

Sensors are placed on the bottom of the movable frames 1112a, 1112b, and 1112c to monitor the growth of the plants. These sensors include but are not limited to optical sensors. As the plants grow, such sensors communicate with the hoist to raise the movable frames 1112a, 1112b, and 1112c. The sensors are calibrated to keep the movable frame a set distance from the plants. When the plants grow to a point that they are closer to the moveable frame, the sensor communicates with the hoist to reel in the line and raise the movable platform.

By raising the movable frames, the light is kept at an optimal distance from the plants. Also, the plants growth is not inhibited or altered by the plants coming into contact with the movable frame or any component on the moveable frame. In some embodiments, other sensors are attached to the movable frame. These sensors include temperature sensors, humidity sensors, fire sensors, carbon monoxide sensors, oxygen sensors, and other sensors for monitoring the growth and development of the plants.

The invention can provide an easy-to-install automated growing module. Some of the features of the preferred embodiment include:
Modules made of movable frames with integrated grow lights and fans.
Power cable, water line, and air hose spool options are available.
Modules give you full control of lights, airflow, humidity, and power for indoor growing operations.
Configurable spool layouts: cable spool positioning and pull directions are customizable to best fit the needed application.
Set scheduled procedures: fully automated lighting, air flow, and humidity.
Adjust height of grow lights to perfectly match the needed distance from plants as they grow and mature.
Configurable with multiple cable spools: the spools can be used with a pulley system to more easily lift larger items in a level, secure, and safe manner.
Control at the module-level means that you can customize growing conditions to multiple crops or crop maturities within the same space.

A sturdy hoist-mounting frame attaches to racking easily and can be adjusted to fit multiple rack widths. Hoists can also be attached to existing ceilings or other mounting surfaces with mounting hardware.

As to power, each hoist can act as a complete grow system, and multiple hoists can be wired in series within operation power limits.

Most indoor grow systems supply water near the roots of the plants, whether in a hydroponic system or a soil-based system. Nevertheless, it some embodiments, the system is also used to provide water from above.

While much of the discussion and figures have focused on growing Cannabis, other plants, such as herbs, vegetables and fruits can also benefit from the system of the present invention.

Although the preferred embodiment of the stackable grow system has stationary platforms and moveable racks with the grow lights and other components being moved to maintain the optimum height above the growing plants, an alternative embodiment includes stationary racks and movable platforms. In other words, the array of lights, the air movers and the water misters are mounted above each platform and stay at a given vertical point. The platforms, with new plants are raised to be just under those components then lowered as the plants grow in height.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for growing plants, the system comprising:
a first platform, configured to support a first set of plants thereon;
a second platform, spaced above the first platform a sufficient distance to allow for full growth of the first set of plants thereunder, and configured to support a second set of plants thereon;
a first moveable frame suspended above the first platform and below the second platform, and having a first array of grow lights mounted thereon;
a second movable frame suspended above the second platform and having a second array of grow lights mounted thereon; and
a lift system configured to raise and lower the first movable frame so as to maintain the first array of grow lights within a predetermined distance above the first set of plants as it grows, and configured to raise and lower the second movable frame so as to maintain the second array of grow lights within the predetermined distance above the second set of plants as it grows.

2. The system of claim 1, further comprising a first air mover system mounted on the first movable frame and a second air mover system mounted on the second movable frame.

3. The system of claim 2, wherein each of the first and second air mover systems comprise an array of fans.

4. The system of claim 2, further comprising a first water mister mounted on the first movable frame and a second water mister mounted on the second movable frame.

5. The system of claim 1, further comprising:
a third platform, spaced above the second platform a sufficient distance to allow for full growth of the plants thereunder, and configured to support a third set of plants thereon; and
a third movable frame suspended above the third platform, and having a third array of grow lights mounted thereon;
wherein the lift system is further configured to raise and lower the third movable frame so as to maintain the third array of grow lights within a predetermined distance above the third set of plants as it grows.

6. The system of claim 1, wherein the lift system comprises:
a first hoist configured to raise and lower the first movable frame relative to the first set of plants by winding a first line onto and off of the first hoist; and
a second hoist configured to raise and lower the second movable frame relative to the second set of plants by winding a second line onto and off of the second hoist.

7. The system of claim 6, further comprising:
a first power cable carried by the first hoist and coupled to the first array of grow lights to provide electrical power thereto, the first power cable being windable onto and off of the first hoist; and
a second power cable carried by the second hoist and coupled to the second array of grow lights to provide electrical power thereto, the second power cable being windable onto and off of the second hoist.

8. The system of claim 6, further comprising:
a first air mover system mounted on the first movable frame;
a first power cable carried by the first hoist and coupled to the first air mover system and to the first array of grow lights to provide electrical power thereto, the first power cable being windable onto and off of the first hoist;
a second air mover system mounted on the second movable frame; and
a second power cable carried by the second hoist and coupled to the second air mover system and to the second array of grow lights to provide electrical power thereto, the second power cable being windable onto and off of the second hoist.

9. The system of claim 8, further comprising:
a first water mister system mounted on the first movable frame;
a first fluid line carried by the first hoist and coupled to the first water mister system to provide water thereto, the first fluid line being windable onto and off of the first hoist;
a second water mister system mounted on the second movable frame; and
a second fluid line carried by the second hoist and coupled to the second water mister system to provide water thereto, the second fluid line being windable onto and off of the second hoist.

10. The system of claim 1, further comprising at least one first sensor to facilitate maintaining the first movable frame an optimum distance above the first set of plants, and at least one second sensor to facilitate maintaining the first movable frame an optimum distance above the second set of plants.

11. The system of claim 1, further comprising at least one first optical sensor to observe the condition of the first set of plants, and at least one second optical sensor to observe the condition of the second set of plants.

12. The system of claim 11, wherein the at least one first optical sensor is mounted on an underside of the first movable frame, and wherein the at least one second optical sensor is mounted on an underside of the second movable frame.

13. The system of claim 1, wherein the first set of plants is arranged in an array with at least one row and at least 4 columns, and wherein the second set of plants is arranged in an array with at least one row and at least 4 columns.

14. The system of claim 1, wherein the first set of plants is arranged in an array with at least 3 rows and at least 6 columns, and wherein the second set of plants is arranged in an array with at least 3 rows and at least 6 columns.

15. A method for growing plants, the system comprising:
providing a first shelf, configured to support a first set of plants thereon;
providing a second shelf, spaced above the first shelf a sufficient distance to allow for full growth of the first set of plants thereunder, and configured to support a second set of plants thereon;
providing a first moveable frame suspended above the first shelf and below the second shelf, and having a first array of grow lights mounted thereon;
providing a second movable frame suspended above the second shelf and having a second array of grow lights mounted thereon; and
providing a lift system configured to raise and lower the first movable frame;
maintaining the first array of grow lights within a predetermined distance above the first set of plants and the second array of grow lights a predetermined distance above the second set of plants as they grow, and
raising and lowering the first and second movable frames so as to maintain the first and second arrays of grow lights within the predetermined distance above the first and second set of plants as they grow.

16. The method of claim 15, further comprising a first air mover system mounted on the first movable frame and a second air mover system mounted on the second movable frame.

17. The method of claim 16, wherein each of the first and second air mover systems comprise an array of fans.

18. The method of claim 16, further comprising a first water mister mounted on the first movable frame and a second water mister mounted on the second movable frame.

19. The method of claim 15, further comprising at least one first optical sensor to observe the condition of the first set of plants, and at least one second optical sensor to observe the condition of the second set of plants.

20. The method of claim 19, wherein the at least one first optical sensor is mounted on an underside of the first movable frame, and wherein the at least one second optical sensor is mounted on an underside of the second movable frame.
